(19) United States
(12) Patent Application Publication
(10) Pub. No.: US 2019/0303907 A1
(43) Pub. Date: Oct. 3, 2019

(54) CURRENCY TYPE SWITCHING METHOD AND DEVICE

(71) Applicant: ALIBABA GROUP HOLDING LIMITED, Grand Cayman (KY)

(72) Inventor: Fei NI, HANGZHOU (CN)

(21) Appl. No.: 16/442,686

(22) Filed: Jun. 17, 2019

Related U.S. Application Data
(63) Continuation of application No. PCT/CN2017/118230, filed on Dec. 25, 2017.

(30) Foreign Application Priority Data
Jan. 3, 2017 (CN) 201710002177.9

(51) Int. Cl. G06Q 20/32; G06Q 20/22

(52) U.S. Cl. CPC G06Q 20/322; G06Q 20/227

(57) ABSTRACT

Methods, systems, and apparatus, including computer programs encoded on computer storage media, for a currency type switching method are provided. One of the methods includes: determining a transaction currency type and a transaction channel of a transaction; determining whether the transaction channel supports the transaction currency type; and in response to a determination that the transaction channel does not support the transaction currency type, changing the transaction currency type to a designated currency type supported by the transaction channel. By automatically changing the transaction currency type to a supported currency type, this method eliminates the cumbersome processes a user otherwise needs to go through to manually change the transaction currency type, hence it enhances the user experiences in an online transaction.

### CROSS-REFERENCE TO RELATED APPLICATIONS

This application is a continuation application of International Patent Application No. PCT/CN2017/118230, filed on Dec. 25, 2017, which is based on and claims priority to the Chinese Patent Application No. 201710002177.9, filed on Jan. 3, 2017 and entitled “CURRENCY TYPE SWITCHING METHOD AND DEVICE.” The above-referenced applications are incorporated herein by reference in their entirety.

### TECHNICAL FIELD

This application relates generally to payment technologies, and more specifically, to a currency type switching method and related devices.

### BACKGROUND

In some payment applications, a transaction channel may support several different currency types, so a user may select any of these supported currency types to complete a transaction.

FIG. 1 shows a diagram illustrating an order confirmation interface in accordance with some embodiments of this application. As shown in FIG. 1, when a user orders a product in an international e-commerce platform, he/she may select one of several different currency types, such as Chinese Yuan (RMB), United States Dollar (USD), Euro (EUR), British Pound (GBP), Japanese Yen (JPY), and South Korean Won (KRW), for the transaction. Generally, after the order is confirmed, the user may enter a checkout interface of a checkout device (e.g., installed on a mobile phone), as shown in FIG. 2, to choose a transaction channel (“Transaction Channel” as shown in FIG. 2) to complete the transaction. For example, in FIG. 2, “Alipay” is selected as the transaction channel. Then, after verifying the order, the user may click a “Pay” button to complete the transaction.

In conventional techniques, after a user selected a transaction channel for the transaction, the checkout device will verify whether the selected transaction channel supports a transaction currency type the user selected. In some scenarios, the selected transaction currency type may not be supported by the transaction channel. For example, a user may selected JPY as the transaction currency type, while the transaction channel may not support JPY. In conventional techniques, in that case, the checkout device will notify the user that the transaction cannot be completed, and the user has to manually change the transaction currency type and try again.

In the example described above, the user needs to go through at least three steps (i.e., exit the checkout interface, select another currency type, and enter the checkout interface to try again) to change the transaction currency type. These cumbersome processes slows down the online transaction and adversely affects the user experiences.

### SUMMARY

In view of the limitations described above, a currency type switching method and related devices are provided to address the issues of conventional techniques.

A currency type switching method in accordance with some embodiments of this application comprises determining a transaction currency type and a transaction channel of a transaction; determining whether the transaction channel supports the transaction currency type; and, in response to a determination that the transaction channel does not support the transaction currency type, changing the transaction currency type to a designated currency type supported by the transaction channel.

The specification further provides a transaction channel switching method. According to some embodiments, the method comprises determining a transaction currency type and a transaction channel of a transaction; determining whether the transaction channel supports the transaction currency type; and, in response to a determination that the transaction channel does not support the transaction currency type, changing the transaction channel to a designated channel that supports the transaction currency type.

The specification further provides a currency type switching device. According to some embodiments, the device comprises one or more processors and one or more non-transitory machine-readable memories coupled to the one or more processors and configured with instructions executable by the one or more processors to cause the device to perform operations. According to some embodiments, the operations comprise determining a transaction currency type and a transaction channel of a transaction; determining whether the transaction channel supports the transaction currency type; and changing the transaction currency type to a designated currency type supported by the transaction channel in response to a determination that the transaction channel does not support the transaction currency type.

The specification further provides a transaction channel switching device. According to some embodiments, the device comprises one or more processors and one or more non-transitory machine-readable memories coupled to the one or more processors and configured with instructions executable by the one or more processors to cause the device to perform operations. According to some embodiments, the operations comprise: determining a transaction currency type and a transaction channel of a transaction; determining whether the transaction channel supports the transaction currency type; and changing the transaction channel to a designated channel that supports the transaction currency type in response to a determination that the transaction channel does not support the transaction currency type.

This specification further provides a currency type switching method. According to some embodiments, this method comprises: determining a user-selected currency type and a paying channel for a payment; determining whether the paying channel supports the user-selected currency type; and, if the paying channel does not support the user-selected currency type, switching the currency type to a currency type supported by the paying channel.

Optionally, determining whether the paying channel supports the user-selected currency type includes: determining a set of currency types supported by the paying channel; and determining whether the user-selected currency type belongs to the set of currency types.

Correspondingly, if the paying channel does not support the user-selected currency type, the step of switching the user-selected currency type to a currency type supported by the paying channel includes: if the user-selected currency type does not belong to the set of currency types, switching the user-selected currency type to a currency type within the set of currency types.

Optionally, the step of switching the user-selected currency type to a currency type supported by the paying channel specifically includes: acquiring a second currency type supported by an account of a user; determining whether the paying channel supports the second currency type; and, if the paying channel supports the second currency type, switching the user- selected currency type to the second currency type.

Optionally, the step of switching the user-selected currency type to the second currency type if the paying channel supports the second currency type includes: if the paying channel supports the second currency type, acquiring a payment amount of the payment; determining whether an account balance or a credit limit of the second currency type exceeds the payment amount; and, if the account balance or the credit limit of the second currency type exceeds the payment amount, switching the user-selected currency type to the second currency type.

Optionally, the aforementioned method further includes: calculating a payment amount of the currency type after switching according to an exchange rate.

This specification further provides a paying channel switching method. According to some embodiments, the method includes: determining a user-selected currency type and a paying channel for a payment; determining whether the paying channel supports the user-selected currency type; and, if the paying channel does not support the user-selected currency type, switching the paying channel to a paying channel supporting the user-selected currency type.

Optionally, determining whether the paying channel supports the user-selected currency type includes: determining a set of currency types supported by the paying channel; and determining whether the user-selected currency type belongs to the set of currency types.

Correspondingly, if the paying channel does not support the user-selected currency type, switching the paying channel to a paying channel supporting the currency type includes: if the user-selected currency type does not belong to the set of currency types, switching the paying channel to a paying channel supporting the currency type.

Optionally, switching the paying channel to a paying channel supporting the currency type includes: acquiring second paying channels supporting the user-selected currency type; according to historical usage information of the second paying channels, determining a second paying channel to be switched to the second paying channels; and switching the paying channel to the second paying channel to be switched to.

Optionally, determining a second paying channel to be switched to from the second paying channels according to the historical usage information of the second paying channels includes: according to a number of historical uses of the second paying channels, selecting a second paying channel with the largest number of historical uses as the second paying channel to be switched to.

Optionally, determining a second paying channel to be switched to from the second paying channels according to the historical usage information of the second paying channels includes: according to the time of latest usage of the second paying channels, selecting a second paying channel with the latest usage time as the second paying channel to be switched.

The currency type switching device provided by the embodiments of this application includes: a determination unit which acquires a user-selected currency type and a paying channel for a payment; a judging unit which determines whether the paying channel supports the user-selected currency type; and a switch unit which switches the user-selected currency type to a currency type supported by the paying channel, if the paying channel does not support the user-selected currency type.

Optionally, the judging unit includes: a determination subunit which determines a set of currency types supported by the paying channel; and a judging subunit which determines whether the user-selected currency type belongs to the set of currency types.

Correspondingly, the switch unit is configured to: switch the user-selected currency type to a currency type within the set of currency types, if the user-selected currency type does not belong to the set of currency types.

Optionally, the switch unit includes: a first acquisition subunit which acquires a second currency type supported by an account of a user; a first judging subunit which determines whether the paying channel supports the second currency type; and a switch subunit which switches the user-selected currency type to the second currency type, if the paying channel supports the second currency type.

Optionally, the switch subunit includes: a second acquisition subunit which acquires a payment amount of the payment, if the paying channel supports the second currency type; a second judging subunit which determines whether an account balance or a credit limit of the second currency type exceeds the payment amount; and a second switch subunit which switches the user-selected currency type to the second currency type, if the account balance or the credit limit of the second currency type exceeds the payment amount.

Optionally, the device further includes: a calculation unit which calculates a payment amount of the currency type after switching according to an exchange rate.

This specification further provides a paying channel switching device. According to some embodiments, the device includes: a determination unit which determines a user-selected currency type and a paying channel for a payment; a judging unit which determines whether the paying channel supports the user-selected currency type; and a switch unit which switches the paying channel to a paying channel supporting the currency type, if the paying channel does not support the user-selected currency type.

Optionally, the judging unit includes: a determination subunit which determines a set of currency types supported by the paying channel; and a judging subunit which determines whether the user-selected currency type belongs to the set of currency types.

Correspondingly, the switch unit is configured to: if the user-selected currency type does not belong to the set of currency types, switch the paying channel to a paying channel supporting the currency type.

Optionally, the switch unit includes: an acquisition subunit which acquires second paying channels supporting the currency type; a determination subunit which determines a second paying channel to be switched to from the second paying channels, according to historical usage information of the second paying channels; and a switch subunit which switches the paying channel to the second paying channel to be switched.

Optionally, the determination subunit is configured to: according to a number of historical uses of the second paying channels, select a second paying channel with the largest number of historical uses as the second paying channel to be switched to.

Optionally, the determination subunit is configured to: according to the time of latest usage of the second paying channels, select a second paying channel with the latest usage time as the second paying channel to be switched.

In some embodiments of this application, in case the original transaction currency type a user selected is not supported by the transaction channel, the method or device automatically changes the transaction currency type to a supported currency type, or change the transaction channel to a channel that supports the transaction currency type. By automatically changing the transaction currency type or the transaction channel, this method or device eliminates the cumbersome processes the user otherwise needs to go through to manually change the transaction currency type or transaction channel, thus it improves the user experiences in an online transaction.

### BRIEF DESCRIPTION OF THE DRAWINGS

The drawings illustrate some embodiments of this application, and along with the specification, will be used to describe the embodiments of this application. The accompanying drawings only illustrate some embodiments, and thus are not an exhaustive depiction, of this application. Therefore this application is not limited by the drawings presented herein. Other drawings of the embodiments can be derived from the drawings presented herein by one of ordinary skill in the art without creative efforts.

FIG. 1 shows a diagram illustrating an order confirmation interface in accordance with some embodiments of this application.

FIG. 2 shows a diagram illustrating a checkout interface in accordance with some embodiments of this application.

FIG. 3 shows a flowchart illustrating a currency type switching method in accordance with some embodiments of this application.

FIG. 4 shows a diagram illustrating a change of the currency type in accordance with some embodiments of this application.

FIG. 5 shows a flowchart illustrating a transaction channel switching method in accordance with some embodiments of this application.

FIG. 6 shows a diagram illustrating a change of the transaction channel in accordance with some embodiments of this application.

FIG. 7 shows a hardware structure diagram illustrating an apparatus comprising a currency type switching device in accordance with some embodiments of this application.

FIG. 8 shows a modular diagram illustrating a currency type switching device in accordance with some embodiments of this application.

FIG. 9 shows a hardware structure diagram illustrating an apparatus comprising a transaction channel switching device in accordance with some embodiments of this application.

FIG. 10 shows a modular diagram illustrating a transaction channel switching device in accordance with some embodiments of this application.

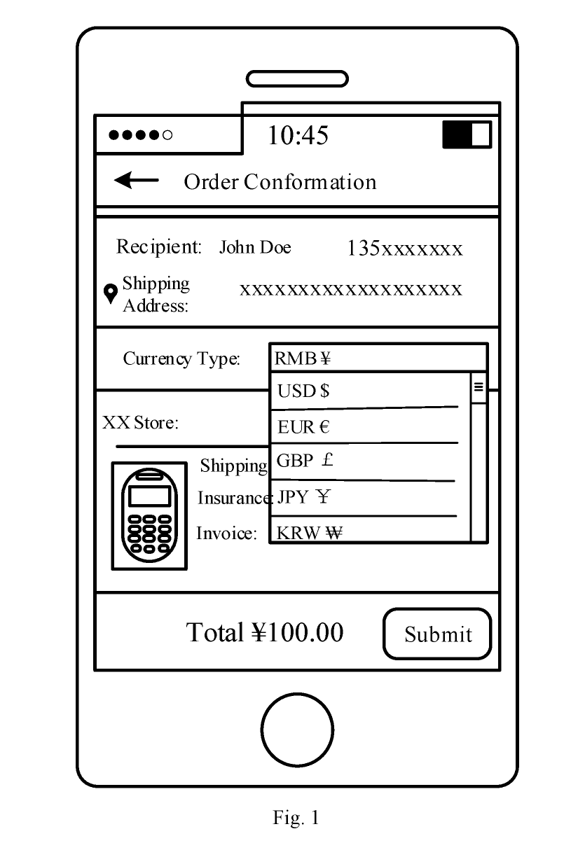

### DETAILED DESCRIPTION OF THE EMBODIMENTS

Some embodiments of this application are described below with reference to the accompanying drawings. As those of ordinary skill in the art would appreciate, the drawings and descriptions are illustrative and not restrictive. Unless clearly indicated otherwise, like reference numerals may be used to designate like elements in the specification. To the extent possible, any repetitive description will be minimized to serve the purpose of conciseness and convenience.

The terminologies used herein are for the purpose of describing particular embodiments, and are not intend to limit this application. As used herein, singular forms, “a,” “an,” and “the” may indicate plural forms as well, unless the context clearly indicates otherwise. The term “and/or”, when used in this specification, may indicate and include any or all possible combinations of one or more listed items.

Although the terms “first,” “second,” “third,” etc. may be used to describe various elements, these elements should not be limited by these terms. These terms may be used to distinguish one element from another. Thus, a first element may be termed a second element (and vice versa) without departing from the teachings of this specification. Depending on the context, the term “if” as used herein may be interpreted as “when,” “upon,” or “in response to.”

As mentioned above, in some online transactions, when a user selected a transaction currency type and a transaction channel for a transaction, a checkout device will verify whether the transaction channel supports the transaction currency type. In some scenarios, the transaction currency type may not be supported by the transaction channel. For example, a user may selected JPY as the transaction currency, while the transaction channel may not support JPY. In conventional techniques, in that case, the checkout device will notify the user that the transaction cannot be completed, and the user has to manually change the transaction currency type and try again.

In the example described above, the user needs to go through at least three steps (i.e., exit the checkout interface, select another currency type, and enter the checkout interface to try again) to change the transaction currency type. These cumbersome processes slow down the online transaction and adversely affect the user experiences.

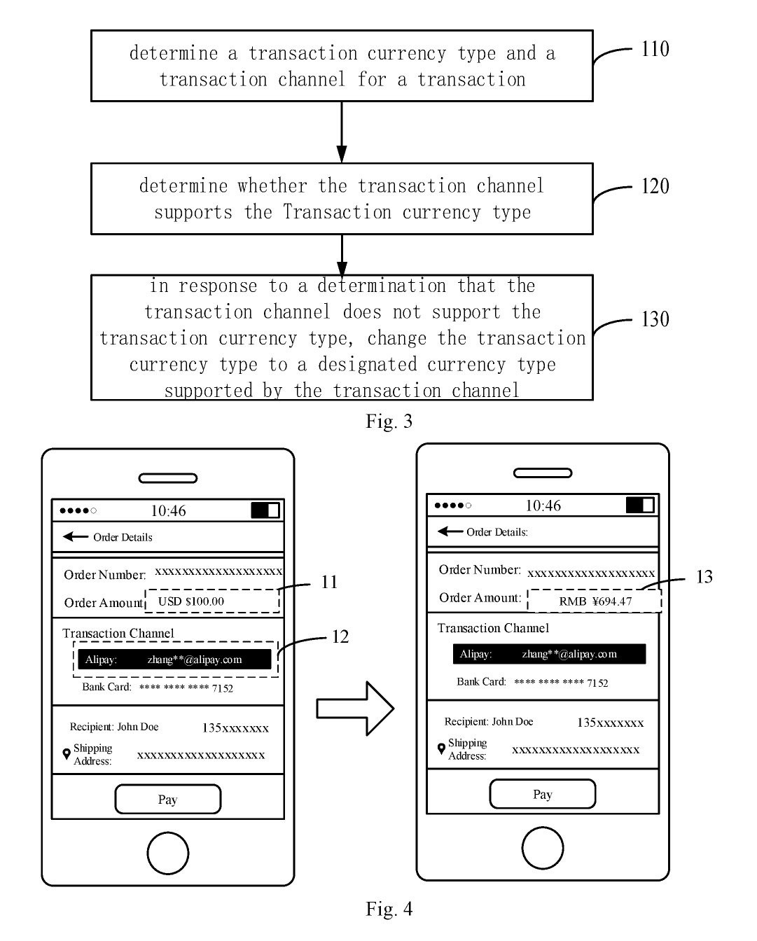

FIG. 3 shows a flowchart illustrating a currency type switching method in accordance with some embodiments of this application. This method addresses at least some limitations of the conventional techniques described above. The method comprises the following steps.

In step 110, a transaction currency type and a transaction channel a user selected are determined.

In some embodiments, after the transaction currency type is selected, the user may enter a checkout interface of a checkout device to complete the transaction, in which the user may select a transaction channel for the transaction. The checkout device may determine the transaction channel and the transaction currency type the user selected. In some embodiments, the checkout device may be software installed on a mobile device.

The transaction currency type and the transaction channel both have a default value. For example, the default value of the transaction channel may be the transaction channel used in the last transaction, and default value of the transaction currency type may be the transaction currency type used in the last transaction.

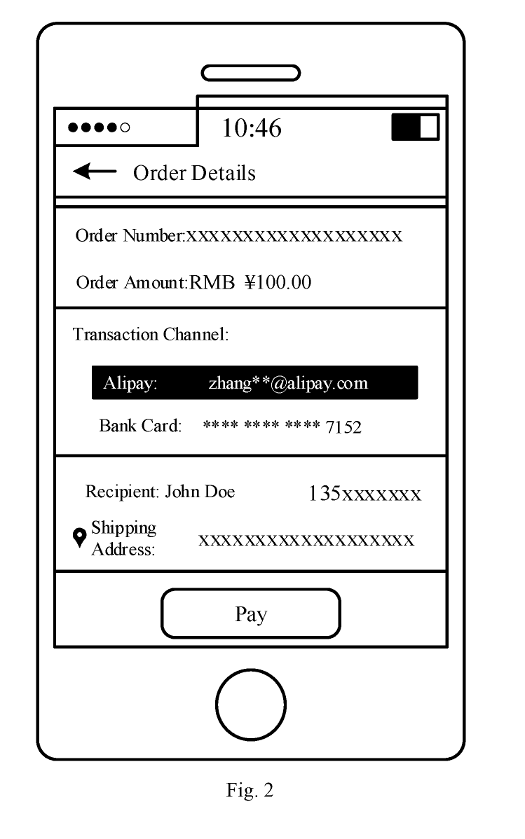

FIG. 2 shows a diagram illustrating a checkout interface of a checkout device in accordance with some embodiments of this application.

Referring to FIG. 2, the checkout device may determine that the transaction currency type is RMB based on the information in the field of “Order Amount,” and determine that the transaction channel is “Alipay” based on the information in the field of “Transaction Channel” (highlighted in FIG. 2).

The techniques involved in the payment in the embodiments of this application may include, for example, Near Field Communication (NFC), WIFI, 3G/4G/5G technologies, POS card swiping technology, two-dimensional code scanning technology, barcode scanning technology, Bluetooth technology, infrared ray technology, Short Message Service (SMS), and Multimedia Message Service (MMS), etc.

In step 120, the checkout device determines whether the transaction channel supports the transaction currency type.

In some embodiments, the checkout device may make the determination after the transaction channel and transaction currency type are determined.

If it is determined that the transaction channel does not support the transaction currency type, step 130 (which will be described below) may be performed. Otherwise, the transaction may be completed once the user submits the order.

In step 130, the transaction currency type is changed to a currency type that is supported by the transaction channel.

More specifically, in step 120, determining whether the transaction channel supports the transaction currency type may comprise:

determining the supportable currency types that can be supported by the transaction channel; and

determining whether the transaction currency type is one of the supportable currency types.

Accordingly, step 130 may comprise changing the transaction currency type to one of the supportable currency types if the transaction currency type is not supported by the transaction channel.

In some embodiments, each transaction channel may have a collection of the supportable currency types, with each of these collections comprises at least one supportable currency type that is supported by the corresponding transaction channel.

FIG. 4 shows a diagram illustrating a change of the currency type in accordance with some embodiments of this application. In FIG. 4, the transaction currency type the user initially selected for the transaction is USD, as shown in the dash box 11, and the transaction channel the user selected is “Alipay,” as shown in the dash box 12. For ease of description, it is assumed that the supportable currency types that are supported by Alipay are: {RMB, EUR, GBP}.

Since USD is not one of the supported currency types of Alipay, the user needs to change the currency type to one of the supportable currency types. For example, as shown in the dash box 13 of FIG. 4, the currency type may be changed to “RMB.”

In some embodiments, when the transaction channel does not support the transaction currency type selected by a user, the checkout device may automatically change the transaction currency type to one of the supportable currency types (a designated currency type) that is supported by the transaction channel. Thus, the user does not need to manually change the currency type, which improves the efficiency, and thus the user experiences, of the payment process.

The method illustrated in FIG. 3 may further comprise calculating a payment amount in the designated currency type according to an exchange rate after the transaction currency type is changed to the designated currency type that is supported by the transaction channel.

In some embodiments, the exchange rate may be a real-time exchange rate, which may be provided by a bank.

In addition to changing the transaction currency type to a designated currency type that is supported by the transaction channel, this method may further comprise computing a payment amount in the designated currency type. For example, as shown in the dash box 13 of FIG. 4, after the currency type is changed from USD to RMB, this method may further compute a payment amount in the designated currency type is ¥694.47.

Thus, in some embodiments, the payment amount is automatically updated after the transaction currency type is changed, which further improves the user experiences.

In actual transactions, the number of currency types that are supported by a user's account may also be limited. For example, a user may only enable transactions in USD and RMB, thus the user's account may only support a transaction in these two currency types, and any other currency type is not supported. Therefore, the currency type selected by the checkout interface should also be one of the currency types supported by the user's account, otherwise the transaction cannot go through.

To address this issue, in some embodiments, the process to change the transaction currency type to the designated currency type supported by the transaction channel may comprise the following steps:

step A1: a second currency type that is supported by the user's account is determined;

step A2: the second currency type is selected and it is determined that whether the selected second currency type is supported by transaction channel; and

step A3: if the second currency type is supported by the transaction channel, the transaction currency type is changed to the selected second currency type.

For example, in the example described above, the transaction currency type the user initially selected is USD, and the currency types the transaction channel supports are {RMB, EUR, GBP}. Since the selected transaction currency type (USD) is not supported by the transaction channel, the transaction currency type needs to be changed to one of the currency types that is supported by the transaction channel.

At this time, second currency types that are supported by the user's account may be determined. The second currency types may include all the currency types the user's account supports, except the one the user has selected. For example, if the currency types supported by the user's account are {USD, JPY, RMB, EUR}, then the second currency types may be: {JPY, RMB, EUR}. Note that USD is excluded from the second currency types since USD has been determined to be not supported by the transaction channel.

One of the second currency types that is supported by the transaction channel will be selected as the transaction currency type. For example, in the example presented above, since JPY is not supported by the transaction channel, RMB will be selected as the transaction currency type.

The choice of the second channel in this step may be made on a “first-come, first-serve” basis, therefore even though EUR is also one of the second currency types that is supported by the transaction channel (therefore potentially may also be selected as the transaction currency type), RMB is selected because it is visited before EUR.

In some embodiments, when the transaction channel does not support the transaction currency type a user selected, the checkout device may first determine the second currency types that are supported by the user's account, and selects one of the second currency types as the transaction currency type (the designated currency type). Therefore it ensures that the new transaction currency type will be the currency type that is supported by the user's account.

In actual transactions, after the transaction currency type is determined, there still a potential issue that there may be not enough balance in the transaction currency type to complete the transaction.

To address this issue, in some embodiments, the step A3 described above may comprise the following steps:

step A31: determining a payment amount in the second currency type for the transaction;

step A32: determining whether a remaining balance of the second currency type or a credit limit of the second currency type exceeds the payment amount; and

step A33: changing the transaction currency type to the second currency type if the remaining balance or the credit limit of the second currency type exceeds the payment amount.

In some embodiments, the remaining balance may be a remaining balance in the user's account or in the user's debit card, the credit limit may be a credit limit of the user's credit card, and “exceed” may mean “greater or equal to.”

Referring to FIG. 4, when the transaction channel supports the second currency type (RMB), the payment amount of this transaction is calculated to be ¥694.47.

Assuming a remaining balance of the user's account is ¥1000 in RMB, which exceeds the payment amount, then the transaction currency type may be changed to RMB (the second currency type).

In these embodiments, it is ensured that the new currency type selected for the transaction currency type is not only supported by the user's account, but also has enough balance or credit limit for the payment. Thus, it avoids the problem that the transaction may fail due to insufficient fund after the transaction currency type is changed to a new currency type.

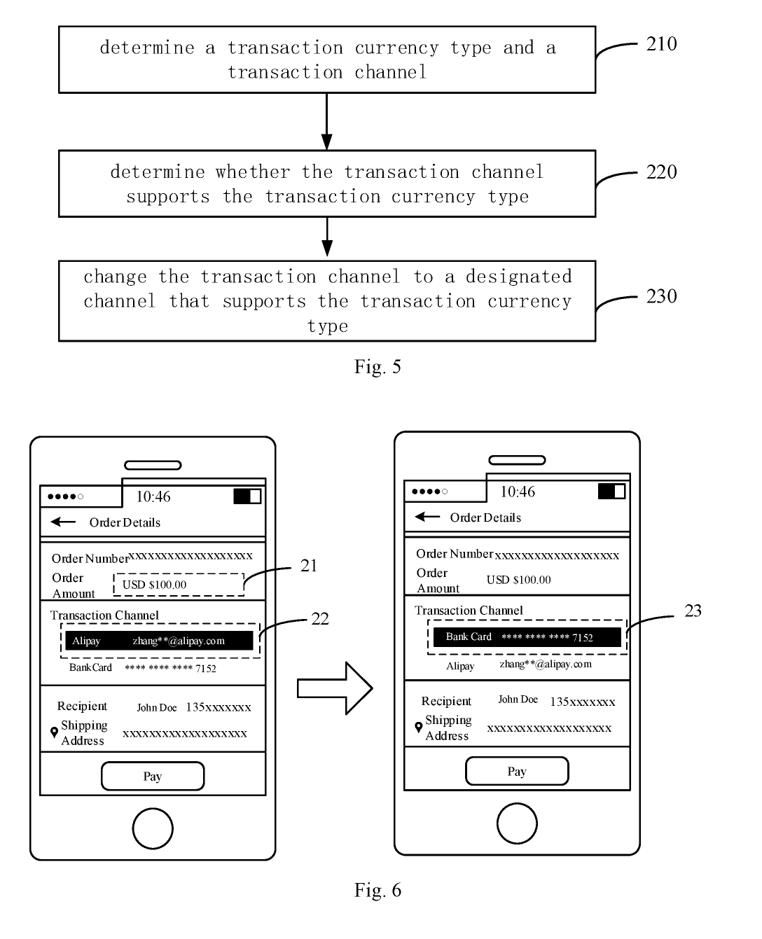

To address the issues in conventional techniques, FIG. 5 shows a flowchart illustrating a transaction channel switching method in accordance with some embodiments of this application. The method comprises:

Step 210: determining a transaction currency type and a transaction channel of a transaction. This step is the same as step 110 described above. Thus the details of this step are not repeatedly described here for the purpose of conciseness and convenience.

Step 220: determining whether the transaction channel supports the transaction currency type.

In some embodiments, if it is determined that the transaction channel does not support the transaction currency type, step 230 (which will be described below) may be performed. Otherwise, the transaction may be completed once the user submits the order.

Step 230: changing the transaction channel to a designated channel that supports the transaction currency type if the transaction channel does not support the transaction currency type.

More specifically, in step 220, determining whether the transaction channel supports the transaction currency type may comprise:

determining supportable currency types that can be supported by the transaction channel; and

determining whether the transaction currency type is one of the supportable currency types.

Accordingly, step 230 may comprise:

changing the transaction channel to the designated channel that supports the transaction currency type in response to the determination that the transaction currency type is not one of the supportable currency types.

In some embodiments, each transaction channel may have a collection of the supportable currency types, with each of these collections comprises at least one supportable currency type that is supported by the corresponding transaction channel.

FIG. 6 shows a diagram illustrating a change of the transaction channel in accordance with some embodiments of this application. In FIG. 6, the transaction currency type the user selected for the transaction is USD, as shown in the dash box 21, and the transaction channel is “Alipay,” as shown in the dash box 22. For the ease of description, it is assumed that the supportable currency types that are supported by Alipay is: {RMB, EUR, GBP}.

Since USD is not one of the supported currency types of Alipay, the user needs to change the transaction channel to a channel that supports the transaction in USD.

For example, assuming the transaction channel of “Bank Card” supports the transaction currency type of both RMB and USD. Since USD is supported by the transaction channel of “Bank Card,” the transaction channel may be changed to “Bank Card,” as shown in the dash box of 23 in FIG. 6.

In some embodiments, when the transaction channel does not support the transaction currency type selected by a user, the checkout device may automatically change the transaction channel to one of the transaction channels that supports the transaction currency type (the designated channel). Thus, the user does not need to manually change the transaction channel, which improves the efficiency, and thus the user experiences, of the payment process.

When changing the transaction channel to a channel that supports the transaction currency type, there may exist multiple channels all of which support the transaction currency type. In that case, the transaction channel may be changed to one transaction channel randomly selected from these channels.

In some embodiments, changing the transaction channel to the designated channel that supports the transaction currency type comprises:

step B1: determining second channels that support the transaction currency type;

step B2: selecting one second channel as the designated channel based on historical usage information of the second channels; and

step B3: changing the transaction channel to the designated channel.

In some embodiments, the historical usage information of the second channels may be the usage number (i.e., number of successful transactions) for each of the second channels.

Alternatively, the historical usage information of the second channels may be a last-used time (the time of the latest successful transaction) for each of the second channels.

Therefore, step B2 may comprise: comparing usage numbers of the second channels; and selecting one second channel that has the largest usage number as the designated channel.

For example, when the transaction currency type a user selected for the transaction is USD, and there are two second channels (Bank Card A and Bank Card B) both support the transaction currency type. Bank Card A has a usage time of 100, and Bank Card B has a usage time of 50. Then Bank Card A may be selected as the designated channel since it has a larger usage time.

Alternatively, step B2 may comprise: comparing last-used times of the second channels; and, selecting one second channel that has the latest last-used time as the designated channel.

For example, when the transaction currency type a user selected for the transaction is USD, and there are two second channels (Bank Card A and Bank Card B) both support the transaction currency type. Bank Card A has a last-used time of Oct. 10, 2016, and Bank Card B has a last-used time of Oct. 11, 2016. Then, Bank Card B may be selected as the candidate channel because it has a more recent last-used time than Bank Card A.

In some embodiments, when changing the transaction channel to a channel that supports the selected transaction currency type, there may exist multiple channels all of which support the transaction currency type. In that case, the transaction channel may be changed to one channel based on the historical usage information of these channels. That is, the transaction channel may be changed to the channel that has the most usage number, or the latest last-used time. Doing so would ensure that the selected transaction channel is the one that the user has used before.

Corresponding to the aforementioned embodiments of the currency type switching method, this application further provides some embodiments of a currency type switching device.

The embodiment of the currency type switching device of this application may be applied to a checkout device for payment applications. The embodiment of the device may be implemented by software, hardware, or a combination of hardware and software. If implemented by software, this currency type switching device may work as a device in logical meaning, and may be formed by executing corresponding computer program instructions loaded into a memory from a non-volatile memory for operation through a processor of the equipment in which the device is located.

For hardware implementation, FIG. 7 shows a hardware structure diagram illustrating an apparatus comprising a currency type switching device in accordance with some embodiments of this application. As shown in FIG. 7, the apparatus may comprise a processor, a network interface, the memory and the non-volatile memory. Additionally, the apparatus may further comprise other hardware components according to actual functionality requirements.

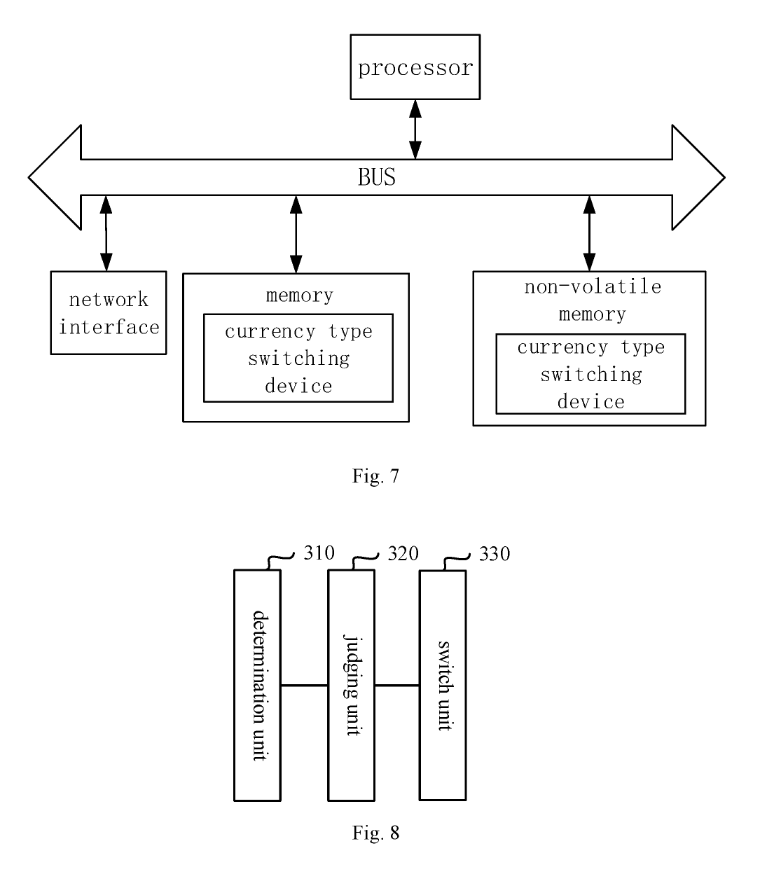

FIG. 8 shows a modular diagram illustrating a currency type switching device in accordance with some embodiments of this application. Referring to FIG. 8, the currency type switching device may comprises a determination unit 310, a judging unit 320, and a switch unit 330.

The determination unit 310 determines a transaction currency type and a transaction channel. The judging unit 320 determines whether the transaction channel supports the transaction currency type. The switch unit 330 changes the transaction currency type to a designated currency type that is supported by the transaction channel if the transaction currency type is not supported by the transaction channel.

In some embodiments, when the transaction channel does not support the transaction currency type selected by a user, the checkout device may automatically change the transaction currency type to one of the supportable currency types (a designated currency type) that is supported by the transaction channel. Thus, the user does not need to manually change the currency type, which improves the efficiency, and thus the user experiences, of the payment process.

In some embodiments, the judging unit 320 may comprise:

a determination subunit for determining supportable currency types supported by the transaction channel;

a judging subunit for determining whether the transaction currency type is one of the supportable currency types.

Accordingly, for the switch unit 33, changing the transaction currency type to the designated currency type that is supported by the transaction channel if the transaction currency type is not supported by the transaction channel comprises: changing the transaction currency type to one of the supportable currency types in response to a determination that the transaction currency type is not one of the supportable currency types.

In some embodiments, when the transaction channel does not support the transaction currency type selected by a user, the checkout device may automatically change the transaction currency type to one of the supportable currency types that is supported by the transaction channel. Thus, the user does not need to manually change the currency type, which improves the efficiency, and thus the user experiences, of the payment process.

In some embodiments, the switch unit 330 may comprise:

a first acquisition subunit for determining second currency types supported by a payment account;

a first judging subunit for determining whether the transaction channel supports one of the second currency types; and

a switch subunit for changing the transaction currency type to the one of the second currency types in response to a determination that the transaction channel supports the one of the second currency types.

In some embodiments, when the transaction channel does not support the transaction currency type a user selected, the checkout device first determines second currency types that are supported by the user's account, and select one of the second currency types that is supported by the transaction channel as the transaction currency type. Therefore, it ensures that the new transaction currency type will be supported by the user's account.

In some embodiments, the switch subunit may comprise:

a second acquisition subunit for determining a payment amount of the transaction in response to the determination that the transaction channel supports the one of the second currency types;

a second determination subunit for determining whether a remaining balance or a credit limit of the one of the second currency types exceeds the payment amount; and

a second switch subunit for changing the transaction currency type to the one of the second currency types in response to a determination that one of the remaining balance or the credit limit of the one of the second currency types exceeds the payment amount.

In these embodiments, the new transaction currency type is not only supported by the user's payment account, but also has sufficient remaining balance or credit limit for the transaction. Thus, it avoids the problem that the transaction may fail due to insufficient fund after the transaction currency type is changed.

In some embodiments, the aforementioned device may further comprise:

a calculation unit for calculating a payment amount in the designated currency type according to an exchange rate after the transaction currency type is changed to the designated currency type.

In these embodiments, the payment amount after the transaction currency type is changed to the designated currency type is automatically updated and displayed for the user, thus it further improves the user experiences.

Additionally, corresponding to the aforementioned transaction channel switching method, this application further provides a transaction channel switching device.

The embodiments of the transaction channel switching device may be applied to a checkout device for payment applications. The embodiment of the device may be implemented by software, hardware, or a combination of hardware and software. If implemented by software, this transaction channel switching device may work as a device in logical meaning, and may be formed by executing corresponding computer program instructions loaded into a memory from a non-volatile memory for operation through a processor of the equipment in which the device is located.

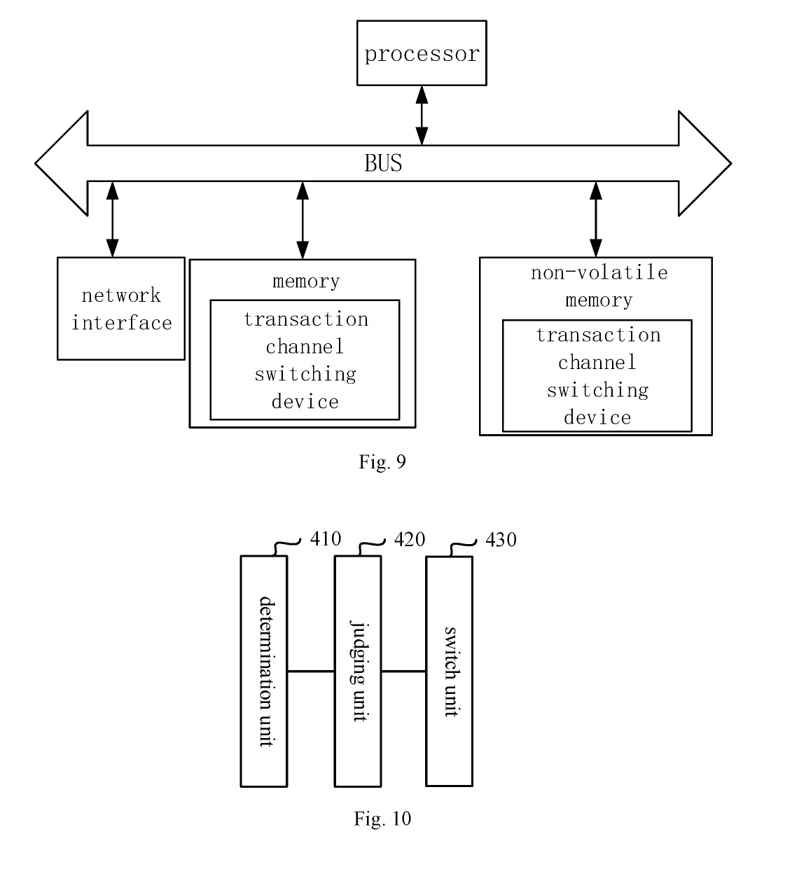

For hardware implementation, FIG. 9 shows a hardware structure diagram illustrating an apparatus comprising a transaction channel switching device in accordance with some embodiments of this application. As shown in FIG. 9, the apparatus may comprise a processor, a network interface, the memory and the non-volatile memory. Additionally, the apparatus may further comprise other hardware components according to actual functionality requirements.

FIG. 10 shows a modular diagram illustrating a transaction channel switching device in accordance with some embodiments of this application. Referring to FIG. 10, this transaction channel switching device may comprise a determination unit 410, a judging unit 420, and a switch unit 430.

The determination unit 410 determines a transaction currency type and a transaction channel of a transaction. The judging unit 420 determines whether the transaction channel supports the transact currency type. The switch unit 430 changes the transaction channel to a designated channel that supports the transaction currency type in response to a determination that the transaction channel does not support the transaction currency type.

In some embodiments, when the transaction channel does not support the transaction currency type selected by a user, the checkout device may automatically change the transaction channel to one of the channels that support the transaction currency type. Thus, the user does not need to manually change the transaction channel, which improves the efficiency, and thus the user experiences, of the payment process.

In one embodiment, the judging unit 420 may comprise:

a determination subunit for determining supportable currency types supported by the selected channel;

a judging subunit for determining whether the transaction currency type is one of the supportable currency types.

Accordingly, for the switching unit 430, changing the transaction channel to the designated channel that supports the transaction currency type in response to the determination that the transaction channel does not support the transaction currency type may comprise:

in response to a determination that the transaction currency type is not one of the supportable currency types, changing the transaction channel to the designated channel that supports the transaction currency type.

In some embodiments, the switch unit 430 may comprise:

an acquisition subunit for determining second channels that support the transaction currency type;

a determination subunit for selecting one of the second channels as the designated channel based on historical usage information of the second channels; and

a switch subunit for changing the transaction channel to the designated channel.

In some embodiments, for the determination subunit, selecting one of the second channels as the designated channel based on the historical information of the second channels may comprise:

comparing usage numbers of the second channels; and

selecting one second channel that has the largest usage number as the designated channel.

In these embodiments, when changing the transaction channel to a channel that supports the transaction currency type, there may exist multiple channels all of which support the transaction currency type. In that case, the transaction channel may be changed to one channel based on the historical usage information of these channels. That is, the transaction channel may be changed to the channel that has the most usage number. Doing so ensures that the selected transaction channel to be the one that the user frequently used.

In some embodiments, for the determination subunit, selecting one of the second channels as the designated channel based on the historical information of the second channels may comprises:

comparing last-used time of the second channels; and

selecting one second channel that has the latest last-used time as the designated channel.

In these embodiments, when changing the transaction channel to a channel that supports the transaction currency type, there may exist multiple channels all of which support the transaction currency type. In that case, the transaction channel may be changed to one channel based on the historical usage information of these channels. That is, the transaction channel may be changed to the channel that has the latest last-used time. Doing so ensures that the selected transaction channel is the one that user has used before.

The system, apparatus, module or unit described in the aforementioned embodiments may be implemented by a computer chip or a computational device, or by a product having a particular function. A typical implementation device is a computer, and the specific form of the computer may be a personal computer, a laptop computer, a cellular telephone, a camera phone, a smartphone, a personal digital assistant, a media player, a navigation device, an email transceiver device, a game console, a tablet computer, a wearable device, or a combination thereof.

The implementation of the functions and effects of the various units in the aforementioned apparatus is described in detail in the implementation of the corresponding steps in the aforementioned method and will not be described in detail herein.

The apparatus embodiments substantially correspond to the method embodiments. Therefore, for related parts of the apparatus embodiments, reference will now be made in part to the description of the method embodiments. The apparatus embodiments described above are merely exemplary. The unit as illustrated by the separation member may or may not be physically separated, the component shown as a unit may or may not be a physical unit, may be located in one place or may be distributed on multiple network units. Some or all of the modules may be selected according to practical requirements to achieve the objectives of the present invention. A person of ordinary skill in the art would understand and implement without the present invention involving any inventive effort.

Other embodiments of this application will be apparent to those skilled in the art from consideration of the specification and practice of the present disclosure disclosed here. This application is intended to cover any variations, uses, or adaptations of this application following the general principles thereof and including such departures from this application as come within known or customary practice in the art. It is intended that the specification and examples be considered as exemplary only, with a true scope and spirit of this application being indicated by the following claims.

It will be appreciated that this application is not limited to the exact construction that has been described above and illustrated in the accompanying drawings, and that various modifications and changes can be made without departing from the scope thereof. It is intended that the scope of this application only be limited by the appended claims.

What is claimed is:

1. A currency type switching method, comprising:
determining a transaction currency type and a transaction channel of a transaction;
determining whether the transaction channel supports the transaction currency type; and
in response to a determination that the transaction channel does not support the transaction currency type, changing the transaction currency type to a designated currency type supported by the transaction channel.

2. The method of claim 1, wherein determining whether the transaction channel supports the transaction currency type comprises:
determining supportable currency types supported by the transaction channel; and
determining whether the transaction currency type is one of the supportable currency types,
and wherein in response to the determination that the transaction channel does not support the transaction currency type, changing the transaction currency type to the designated currency type supported by the transaction channel comprises:
in response to a determination that the transaction currency type is not one of the supportable currency types, changing the transaction currency type to one of the supportable currency types.

3. The method of claim 1, wherein changing the transaction currency type to a designated currency type supported by the transaction channel comprises:
determining a second currency type supported by a payment account of the transaction;
determining whether the transaction channel supports the second currency type; and
in response to a determination that the transaction channel supports the second currency type, changing the transaction currency type to the second currency type.

4. The method of claim 3, wherein in response to the determination that the transaction channel supports the second currency type, changing the transaction currency type to the second currency type comprises:
in response to the determination that the transaction channel supports the second currency type, determining a payment amount of the transaction;
determining whether a remaining balance or a credit limit of the second currency type exceeds the payment amount; and
in response to a determination that one of the remaining balance or the credit limit of the second currency type exceeds the payment amount, changing the transaction currency type to the second currency type.

5. The method of claim 1, further comprising:
calculating a payment amount in the designated currency type according to an exchange rate after changing the transaction currency type to the designated currency type.

6. A transaction channel switching method, comprising:
determining a transaction currency type and a transaction channel of a transaction;
determining whether the transaction channel supports the transaction currency type; and
in response to a determination that the transaction channel does not support the transaction currency type, changing the transaction channel to a designated channel that supports the transaction currency type.

7. The method of claim 6, wherein determining whether the transaction channel supports the transaction currency type comprises:
determining supportable currency types supported by the transaction channel;
determining whether the transaction currency type is one of the supportable currency types,
and wherein in response to the determination that the transaction channel does not support the transaction currency type, changing the transaction channel to the designated channel that supports the transaction currency type comprises:
in response to a determination that the transaction currency type is not one of the supportable currency types, changing the transaction channel to the designated channel that supports the transaction currency type.

8. The method of claim 6, wherein changing the transaction channel to a designated channel that supports the transaction currency type comprises:
determining second channels that support the transaction currency type;
selecting one second channel as the designated channel based on historical usage information of the second channels; and
changing the transaction channel to the designated channel.

9. The method of claim 8, wherein selecting one second channel as the designated channel based on the historical usage information of the second channels comprises:
comparing usage numbers of the second channels; and
selecting one second channel that has the largest usage number as the designated channel.

10. The method of claim 8, wherein selecting one second channel as the designated channel based on the historical usage information of the second channels comprises:
comparing last-used times of the second channels; and
selecting one second channel that has the latest last-used time as the designated channel.

11. A currency type switching device comprises one or more processors and one or more non-transitory machine-readable memories coupled to the one or more processors and configured with instructions executable by the one or more processors to cause the device to perform operations comprising:
determining a transaction currency type and a transaction channel of a transaction;
determining whether the transaction channel supports the transaction currency type; and
changing the transaction currency type to a designated currency type supported by the transaction channel in response to a determination that the transaction channel does not support the transaction currency type.

12. The device of claim 11, wherein determining whether the transaction channel supports the transaction currency type comprises:
determining supportable currency types supported by the transaction channel; and
determining whether the transaction currency type is one of the supportable currency types,
and wherein changing the transaction currency type to a designated currency type supported by the transaction channel in response to a determination that the transaction channel does not support the transaction currency type comprises:
changing the transaction currency type to one of the supportable currency types in response to a determination that the transaction currency type is not one of the supportable currency types.

13. The device of claim 11, wherein changing the transaction currency type to a designated currency type supported by the transaction channel comprises:
determining a second currency type supported by a payment account of the transaction;
determining whether the transaction channel supports the second currency type; and
changing the transaction currency type to the second currency type in response to a determination that the transaction channel supports the second currency types.

14. The device of claim 13, wherein changing the transaction currency type to the second currency type in response to a determination that the transaction channel supports the second currency type comprises:
determining a payment amount of the transaction in response to the determination that the transaction channel supports the second currency type;
determining whether a remaining balance or a credit limit of the second currency type exceeds the payment amount; and
changing the transaction currency type to the second currency type in response to a determination that one of the remaining balance or the credit limit of the second currency type exceeds the payment amount.

15. The device of claim 11, wherein the operations further comprise:
calculating a payment amount in the designated currency type according to an exchange rate after changing the transaction currency type to the designated currency type.
